(19) United States
(12) Patent Application Publication
(10) Pub. No.: US 2025/0201951 A1
(43) Pub. Date: Jun. 19, 2025

(54) POWER STORAGE APPARATUS

(71) Applicant: TOYOTA JIDOSHA KABUSHIKI KAISHA, Aichi-ken (JP)

(72) Inventors: Kodai SHINTANI, Toyota-shi (JP); Satoshi MORIOKA, Okazaki-shi (JP); Seita IWAHASHI, Handa-shi (JP); Yuusuke NOSE, Toyohashi-shi (JP); Masahiro YAMADA, Kariya-shi (JP); Takayuki HIROSE, Kariya-shi (JP); Tomohiro NAKAMURA, Kariya-shi (JP)

(21) Appl. No.: 18/905,148

(22) Filed: Oct. 3, 2024

(30) Foreign Application Priority Data
Dec. 15, 2023 (JP) 2023-212059

(51) Int. Cl. H01M 10/48; H01M 10/0525; H01M 10/0585; H01M 50/103; H01M 50/129; H01M 50/131

(52) U.S. Cl. CPC H01M 10/48; H01M 10/0585; H01M 50/103; H01M 50/129; H01M 50/131; H01M 10/0525

(57) ABSTRACT

A power storage apparatus includes: a power storage module having an electrode body and having a principal surface and a peripheral surface perpendicular to the principal surface; a structure body that has an outer surface and an inner surface more on the peripheral surface side than the outer surface and is arranged in a state of facing the peripheral surface; and an exterior body housing the power storage module and the structure body. The exterior body includes a laminate sheet body arranged so as to cover the outer surface. Between the inner surface and the peripheral surface, a sealed internal space is formed with the laminate sheet body. The internal space is evacuated so as to have a negative pressure relative to a pressure of an external space of the power storage apparatus. A through-hole penetrating from the inner surface to the outer surface is formed in the structure body.

### CROSS-REFERENCE TO RELATED APPLICATION

This application claims priority to Japanese Patent Application No. 2023-212059 filed on Dec. 15, 2023, incorporated herein by reference in its entirety.

### BACKGROUND

### 1. Technical Field

The present disclosure relates to a power storage apparatus.

### 2. Description of Related Art

Various conventional power storage apparatuses are known. Japanese Unexamined Patent Application Publication No. 2004-134210 (JP 2004-134210 A) discloses a bipolar laminated battery as an example of a power storage apparatus. In the laminated battery, sheet-like electrodes are laminated with electrolyte layers interposed therebetween. In the laminated battery, electrodes are laminated at the outermost layers of the laminate such that current collector bodies included in the electrodes are exposed to the battery exterior in the laminating direction of the electrodes and function as terminals.

In detail, on the current collector bodies of the two outermost electrodes, laminate sheets having openings provided at their centers are placed. By sealing four sides of each laminate sheet and attaching edges of the openings of the laminate sheets to the current collector bodies with sealing resin, four sides of each of the bipolar electrodes and the electrolyte layers are reduced-pressure sealed.

### SUMMARY

With the laminated battery of JP 2004-134210 A, it is difficult to measure an inner pressure of the laminated battery after the reduced-pressure sealing. The present disclosure therefore provides a power storage apparatus capable of readily measuring an inner pressure after reduced-pressure sealing.

According to an aspect of the present disclosure, a power storage apparatus includes: a power storage module having an electrode body and having a principal surface and a peripheral surface perpendicular to the principal surface; a structure body that has an outer surface and an inner surface more on the peripheral surface side than the outer surface and is arranged in a state of facing the peripheral surface; and an exterior body housing the power storage module and the structure body. The exterior body includes a laminate sheet body arranged so as to cover the outer surface. Between the inner surface and the peripheral surface, a sealed internal space is formed with the laminate sheet body. The internal space is evacuated so as to have a negative pressure relative to a pressure of an external space of the power storage apparatus. A through-hole penetrating from the inner surface to the outer surface is formed in the structure body.

According to such a configuration, when an outside location corresponding to the through-hole on the laminate sheet body is suctioned (vacuum drawn, specifically), in the case of an equal pressure to that of the internal space, the location is pulled. As a result, the location deforms outward. By an inspector or the like examining the pressure at the time when such a state change occurs, the pressure of the internal space of the power storage apparatus can be known. Therefore, according to the power storage apparatus, an inner pressure of the internal space after reduced-pressure sealing of the power storage apparatus can be readily measured.

The electrode body may be a laminated electrode body having a plurality of electrodes laminated in a first direction perpendicular to the principal surface. The through-hole may extend in the first direction.

According to such a configuration, the inspector or the like may bring a suction site of a suction apparatus into contact with the principal surface side of the power storage module such that the laminate sheet body is suctioned in the laminating direction of the electrodes in the laminated electrode body. Accordingly, the inspection is more readily performed as compared with a configuration of suction from the peripheral surface side of the power storage module.

The structure body may have a base portion extending in the first direction in lateral view of the power storage module, and a wall portion extending from the base portion in a second direction that is oriented toward the peripheral surface, the wall portion being parallel to the principal surface. The through-hole may be formed in the wall portion.

According to such a configuration, the through-hole can extend in the first direction, and the internal space can be secured by the structure body.

The structure body may have a box shape. According to such a configuration, the internal space can be sufficiently secured by the structure body. Furthermore, the laminate sheet body can be reinforced from the inner side of the power storage apparatus by the structure body.

According to the power storage apparatus, the inner pressure after reduced-pressure sealing can be readily measured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a laminated battery;

FIG. 2 is a sectional view taken along the II-II line shown in FIG. 1;

FIG. 3 is a sectional view taken along the III-III line shown in FIG. 1;

FIG. 4 is a perspective view of a structure body;

FIG. 5 is a view for explaining a measurement technique of an inner pressure of an internal space in the laminated battery;

FIG. 6A is a view for explaining a method of manufacturing a first laminate sheet portion;

FIG. 6B is a view for explaining the method of manufacturing the first laminate sheet portion;

FIG. 6C is a view for explaining the method of manufacturing the first laminate sheet portion;

FIG. 6D is a view for explaining the method of manufacturing the first laminate sheet portion;

FIG. 6E is a view for explaining the method of manufacturing the first laminate sheet portion;

FIG. 6F is a view for explaining the method of manufacturing the first laminate sheet portion;

FIG. 6G is a view for explaining the method of manufacturing the first laminate sheet portion;

FIG. 7A is a view for explaining a method of manufacturing the laminated battery of a power storage module and an exterior body;

FIG. 7B is a view for explaining a method of manufacturing the laminated battery of the power storage module and the exterior body;

FIG. 7C is a view for explaining a method of manufacturing the laminated battery of the power storage module and the exterior body;

FIG. 7D is a view for explaining a method of manufacturing the laminated battery of the power storage module and the exterior body; and

FIG. 8 is a view showing a modification of the laminated battery.

### DETAILED DESCRIPTION OF EMBODIMENTS

Hereinafter, embodiments of the present disclosure will be described in detail with reference to the drawings. Note that, for the embodiments described below, the same or common portions are given the same signs in the drawings, and their description is not repeated.

Hereinafter, as an example of a power storage apparatus, a laminated battery is exemplarily described. The laminated battery is mounted on an electrified vehicle such as a hybrid electric vehicle which can travel using motive power from at least one of a motor and an engine or an electric vehicle which travels using driving power obtained with electric energy.

Furthermore, hereinafter, a laminating direction of electrodes in the laminated battery is also referred to as “DR3 direction”. A transverse direction of the laminated battery, perpendicular to the laminating direction, is also referred to as “DR1 direction”. A longitudinal direction of the laminated battery, perpendicular to the laminating direction, is also referred to as “DR2 direction”. The DR1 direction, the DR2 direction, and the DR3 direction are perpendicular to one another.

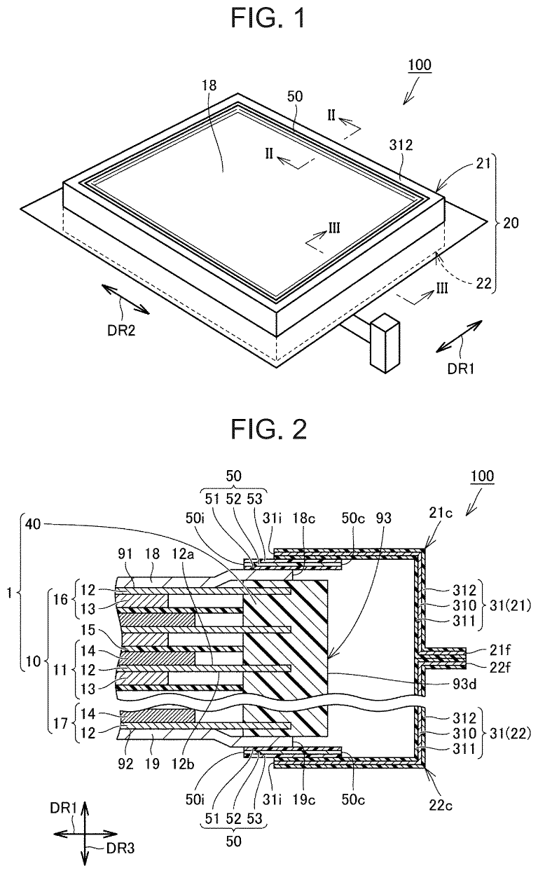

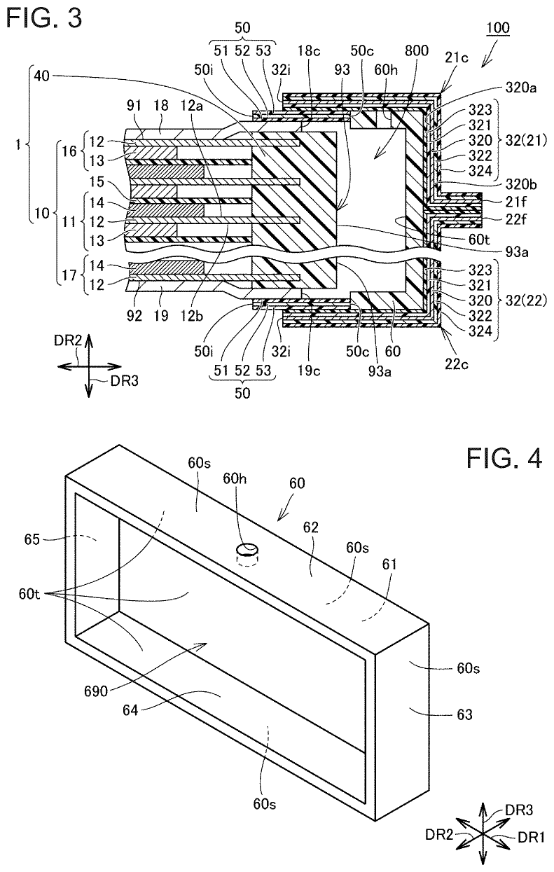

FIG. 1 is a perspective view of a laminated battery according to the present embodiment. FIG. 2 is a sectional view taken along the II-II line shown in FIG. 1. FIG. 3 is a sectional view taken along the III-III line shown in FIG. 1. A laminated battery 100 according to the present embodiment is described with reference to FIG. 1 to FIG. 3.

As shown in FIG. 1 to FIG. 3, the laminated battery 100 includes a power storage module 1 having a laminated electrode body 10 obtained by laminating a plurality of electrodes (electrode plates 11) mentioned later in the laminating direction and a resin scaling body 40, a structure body 60 (FIG. 3), and an exterior body 20 housing the power storage module 1 and the structure body 60.

The power storage module 1 further has a first principal surface 91, a second principal surface 92 on the opposite side to the first principal surface 91, and a peripheral surface 93. The first principal surface 91 and the second principal surface 92 are end surfaces in the DR3 direction. The first principal surface 91 and the second principal surface 92 are parallel to each other. The first principal surface 91 and the second principal surface 92 are surfaces spreading in the DR1 direction and the DR2 direction. The first principal surface 91 is a surface in contact with a first conductive plate 18 mentioned later. The second principal surface 92 is a surface in contact with a second conductive plate 19 mentioned later.

The peripheral surface 93 is a surface perpendicular to the first principal surface 91 and the second principal surface 92. In this example, the peripheral surface 93 is constituted of four end surfaces 93a to 93d (refer to FIGS. 2, 3, 7A, 7B, 7C, 7D). Each of the end surfaces 93a to 93d is a lateral surface of the resin scaling body 40. In this example, each of the end surfaces 93a to 93d is a rectangular plane.

The exterior body 20 is electrically connected to terminating electrodes, mentioned later, of the laminated electrode body 10 and is provided to be able to take out current in the laminating direction to the outside. The exterior body 20 includes the first conductive plate 18, the second conductive plate 19, a first laminate sheet portion 21, a second laminate sheet portion 22, and resin sheets 50. An example of the laminated battery 100 is a secondary battery such as a lithium-ion battery.

The laminated electrode body 10 includes the plurality of electrode plates 11, a plurality of separators 15, a positive electrode terminating electrode 16, and a negative electrode terminating electrode 17. The plurality of electrode plates 11, the positive electrode terminating electrode 16, and the negative electrode terminating electrode 17 are laminated via the separators 15 in the laminating direction (DR3 direction in FIG. 2 and FIG. 3).

Each separator 15 is formed into a sheet shape. Examples of the separators 15 include porous films composed of polyolefin-based resins such as polyethylene (PE) and polypropylene (PP), woven fabric or nonwoven fabric composed of polypropylene, methyl cellulose and the like, and the like. The separators 15 may be reinforced with a vinylidene fluoride resin compound.

The plurality of electrode plates 11 is provided between the positive electrode terminating electrode 16 and the negative electrode terminating electrode 17. An example of an electrode plate 11 is a bipolar electrode. The electrode plate 11 includes a current collector body 12, a positive electrode layer 13, and a negative electrode layer 14.

For example, the current collector body 12 may include at least one selected from the group consisting of aluminum (Al), stainless steel, nickel (Ni), chromium (Cr), platinum (Pt), niobium (Nb), iron (Fe), titanium (Ti), and zinc (Zn). Moreover, the current collector body 12 may be metal foil undergoing plating on a surface.

The current collector body 12 has a first surface 12a positioned on one side in the laminating direction and a second surface 12b positioned on the other side in the laminating direction. On the first surface 12a, the negative electrode layer 14 is provided. On the second surface 12b, the positive electrode layer 13 is provided.

The positive electrode terminating electrode 16 is positioned on one side in the laminating direction. The positive electrode terminating electrode 16 includes the current collector body 12 and the positive electrode layer 13. Specifically, in the positive electrode terminating electrode 16, neither the negative electrode layer 14 nor the positive electrode layer 13 is provided on the first surface 12a of the current collector body 12, and the positive electrode layer 13 is provided on the second surface 12b of the current collector body 12. On the first surface 12a of the current collector body 12 in the positive electrode terminating electrode 16, the first conductive plate 18 is arranged. Note that a center portion (portion except a peripheral edge portion) of the first surface 12a of the current collector body 12 in the positive electrode terminating electrode 16 constitutes a part of the first principal surface 91. The first principal surface 91 includes the center portion of the first surface 12a of the current collector body 12 in the positive electrode terminating electrode 16 and an upper surface of the resin sealing body 40.

The negative electrode terminating electrode 17 is positioned on the other side in the laminating direction. The negative electrode terminating electrode 17 includes the current collector body 12 and the negative electrode layer 14. Specifically, in the negative electrode terminating electrode 17, the negative electrode layer 14 is provided on the first surface 12a of the current collector body 12, and neither the negative electrode layer 14 nor the positive electrode layer 13 is provided on the second surface 12b of the current collector body 12. On the second surface 12b of the current collector body 12 in the negative electrode terminating electrode 17, the second conductive plate 19 is arranged. Note that a center portion (portion except a peripheral edge portion) of the second surface 12b of the current collector body 12 in the negative electrode terminating electrode 17 constitutes a part of the second principal surface 92. The second principal surface 92 includes the center portion of the second surface 12b of the current collector body 12 in the negative electrode terminating electrode 17 and a lower surface of the resin scaling body 40.

The positive electrode layer 13 is formed by applying a positive electrode active material on the second surface 12b. For example, the positive electrode active material that can store and release charge carriers such as lithium ions can be employed. Specifically, the positive electrode active material that can be used as a positive electrode active material for lithium ion secondary batteries, such as a lithium ion composite metal oxide having a lamellar rock salt structure, a metal oxide having a spinel structure, and a polyanion-based compound, can be employed. Moreover, two types or more of positive electrode active materials may be used together, and, for example, the positive electrode active material may include olivine lithium iron phosphate (LiFePO4).

The negative electrode layer 14 is formed by applying a negative electrode active material on the first surface 12a. As the negative electrode active material, for example, lithium, carbon, a metal compound, an element that can be alloyed with lithium or its compound, and the like can be employed.

Note that, in any of the plurality of electrode plates 11, the negative electrode terminating electrode 17, and the positive electrode terminating electrode 16, the peripheral edge portion of the current collector body 12 is an unapplied region where neither the positive electrode layer 13 nor the negative electrode layer 14 is provided.

The resin sealing body 40 is provided so as to seal the periphery of the laminated electrode body 10. Specifically, the resin scaling body 40 seals a cell space that is formed between two adjacent electrode plates 11. An electrolyte solution is injected in each cell space. The resin sealing body 40 is formed through hardening of a resin member such as a hot melt material, a thermoplastic resin, a thermosetting resin, or a photo-curing resin. The resin sealing body 40 is provided in the aforementioned unapplied regions.

The first conductive plate 18 and the second conductive plate 19 are provided such that the laminated electrode body 10 is interposed therebetween in the laminating direction. Specifically, the first conductive plate 18 is arranged on the first surface 12a of the current collector body 12 that is included in the positive electrode terminating electrode 16. Namely, the first conductive plate 18 is arranged on the first principal surface 91 of the current collector body 12 that is included in the positive electrode terminating electrode 16. By being arranged in contact with the first surface 12a, the first conductive plate 18 is electrically connected to the positive electrode terminating electrode 16. By being electrically connected to the positive electrode terminating electrode 16, the first conductive plate 18 functions as a positive electrode terminal of the laminated battery 100.

The second conductive plate 19 is arranged on the second surface 12b of the current collector body 12 that is included in the negative electrode terminating electrode 17. Namely, the second conductive plate 19 is arranged on the second principal surface 92 of the current collector body 12 that is included in the negative electrode terminating electrode 17. By being arranged in contact with the second surface 12b, the second conductive plate 19 is electrically connected to the negative electrode terminating electrode 17. By being electrically connected to the negative electrode terminating electrode 17, the second conductive plate 19 functions as a negative electrode terminal of the laminated battery 100.

With the laminated battery 100, not using tabs for taking out current to the outside, via the first conductive plate 18 functioning as the positive electrode terminal and the second conductive plate 19 functioning as the negative electrode terminal, the current can be taken out from the power storage module 1 housed inside to the outside.

Each of the first conductive plate 18 and the second conductive plate 19 has a rectangular shape having a plurality of corner portions. The peripheral edges of the first conductive plate 18 and the second conductive plate 19 are positioned on the resin scaling body 40.

In this example, the first conductive plate 18 and the second conductive plate 19 are aluminum (Al) plates. Not limited to this, the first conductive plate 18 and the second conductive plate 19 may include at least one selected from the group consisting of aluminum (Al), stainless steel, nickel (Ni), chromium (Cr), platinum (Pt), niobium (Nb), iron (Fe), titanium (Ti), and zinc (Zn). Moreover, the current collector body 12 may be metal foil undergoing plating on a surface.

The first laminate sheet portion 21 is joined to the peripheral edge of the first conductive plate 18. The first laminate sheet portion 21 is joined to the first conductive plate 18 in the state where the resin sheet 50 is interposed between the first laminate sheet portion 21 and the peripheral edge of the first conductive plate 18. The second laminate sheet portion 22 is joined to the peripheral edge of the second conductive plate 19. The second laminate sheet portion 22 is joined to the second conductive plate 19 in the state where the resin sheet 50 is interposed between the second laminate sheet portion 22 and the peripheral edge of the second conductive plate 19.

In this example, the resin sheets 50 are formed of a resin material having insulation ability. The resin sheets 50 are formed of the resin material that can be welded to the first conductive plate 18 and the second conductive plate 19. In this example, the resin sheets 50 are sealant films for insulation.

In detail, each resin sheet 50 has resin layers 51, 52, 53. The resin layer 51 is an inner layer. The resin layer 53 is an outer layer. The resin layer 52 is interposed between the resin layer 51 and the resin layer 53.

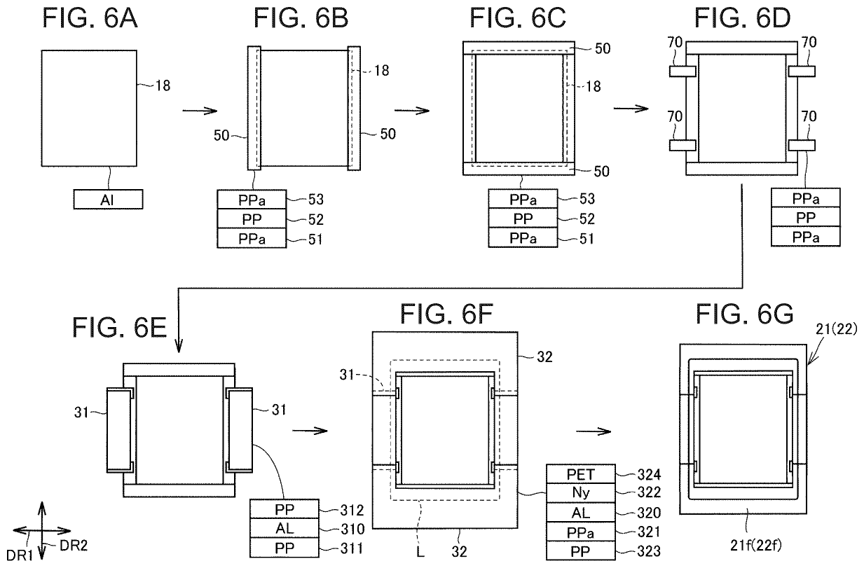

The resin layers 51, 53 are sealant resin layers. As also shown in FIG. 6B and FIG. 6C mentioned later, in this example, the resin layers 51, 53 are layers of acid modified PP (PPa). The resin layer 51 is thermally welded to the first conductive plate 18. In this example, the resin layer 52 is a layer of polypropylene (PP).

Note that a kind of resin forming each of the resin layers 51 to 53 is not limited to the above, and, for example, heat sealing resins such as polyethylene, polypropylene, modified polyethylene, and modified polypropylene can be properly employed.

The center portion of the first conductive plate 18 and the center portion of the second conductive plate 19 are exposed regions that are not coated with the resin sheets 50, the first laminate sheet portion 21, or the second laminate sheet portion 22. Via the exposed regions, current can be directly taken out from the power storage module 1 housed inside to the outside.

The first laminate sheet portion 21 includes a plurality of first sheets 31 and a plurality of second sheets 32 (refer to FIGS. 2, 3, 6A, 6B, 6C, 6D, 6E, 6F, 6G). The plurality of first sheets 31 and the plurality of second sheets 32 cooperatively cover the peripheral edge of the first conductive plate 18. The second laminate sheet portion 22 includes a plurality of first sheets 31 and a plurality of second sheets 32. The plurality of first sheets 31 and the plurality of second sheets 32 that are included in the second laminate sheet portion 22 cooperatively cover the peripheral edge of the second conductive plate 19.

Each first sheet 31 (refer to FIG. 2) has a first metal layer 310 and sealant resin layers 311, 312. The first metal layer 310 has a sheet shape. In this example, as also shown in FIG. 6E mentioned later, the first metal layer 310 is a layer of aluminum foil (Al foil). The first metal layer 310 is not limited to Al foil, and metal foil such as Ni foil, Cu foil, and stainless steel foil can also be used. The first metal layer 310 gives the first sheet 31 resistance to moisture permeation, resistance to gas permeation, and chemical resistance.

The sealant resin layers 311, 312 are provided on both surfaces of the first metal layer 310. Specifically, the sealant resin layer 311 is provided on an inner surface of the first metal layer 310. The sealant resin layer 312 is provided on an outer surface of the first metal layer 310.

The sealant resin layers 311, 312 have compatibility with the resin sheet 50. In this example, the sealant resin layers 311, 312 employ polypropylene (PP). Not limited to this, the sealant resin layers 311, 312 may employ heat sealing resins such as polyethylene, polypropylene, modified polyethylene, and modified polypropylene, for example.

The sealant resin layers 311, 312 function as sealing layers of the exterior body 20. Moreover, the sealant resin layers 311, 312 also have a function as insulating layers, and when the first laminate sheet portion 21 and the second laminate sheet portion 22 are joined, insulate the first laminate sheet portion 21 and the second laminate sheet portion 22.

Each second sheet 32 (refer to FIG. 3) has a second metal layer 320, a first resin layer 321, a second resin layer 322, a third resin layer 323, and a fourth resin layer 324. In the second sheet 32, from the inside toward the outside of the laminated battery 100, the third resin layer 323, the first resin layer 321, the second metal layer 320, the second resin layer 322, and the fourth resin layer 324 are laminated in this order. The fourth resin layer 324 is the outermost layer of the second sheet 32.

In this example, as also shown in FIG. 6F mentioned later, the second metal layer 320 is a layer of Al foil. The first resin layer 321 is a layer of acid modified PP (PPa). The second resin layer 322 is a layer of nylon. The third resin layer 323 is a layer of polypropylene (PP). The fourth resin layer 324, the outermost layer, is a layer of polyethylene terephthalate (PET). The first resin layer 321 is provided on a first principal surface 320a. The second resin layer 322 is provided on a second principal surface 320b.

The second metal layer 320 has a sheet shape. The second metal layer 320 has the first principal surface 320a and the second principal surface 320b. The first principal surface 320a is a surface that is oriented inward (to the side where the laminated electrode body 10 is positioned), and the second principal surface 320b is a surface that is oriented outward (to the opposite side to the side where the laminated electrode body 10 is positioned).

The second metal layer 320 is not limited to Al foil, and metal foil such as Ni foil, Cu foil, and stainless steel foil can be used. A thickness of the second metal layer 320 may be larger than a thickness of the first metal layer 310. The thickness of the second metal layer 320 and the thickness of the first metal layer 310 may be made equal.

The third resin layer 323 has compatibility with the sealant resin layer 312. As the third resin layer 323, other than polypropylene (PP), heat sealing resins such as polyethylene, modified polyethylene, and modified polypropylene can also be employed, for example. Preferably, for the fourth resin layer 324, a resin material having incompatibility with the sealant resin layer 312 may be used.

In the second sheet 32, a layer of nylon (second resin layer 322) and a layer of polyethylene terephthalate (fourth resin layer 324) are overlapped outward of the second metal layer 320. Therefore, the combination of the layers outward of the second metal layer 320 has higher strength than a combination of two layers (the first resin layer 321 and the third resin layer 323) inward of the second metal layer 320 in the second sheet 32. Note that the term “high strength” means high rigidity or tensile strength. Thereby, damage to the second metal layer 320 on the occasion of the second sheet 32 receiving an external force such as pricking may be prevented suitably.

Now, the sealant resin layer 312 of the first sheet 31 (refer to FIG. 2) is a layer of polypropylene (PP) as mentioned above. Therefore, the combination of the layers outward of the second metal layer 320 of the second sheet 32 has higher strength than the sealant resin layer 312 of the first sheet 31. Accordingly, the combination of the layers outward of the second metal layer 320 in the second sheet 32 has higher strength than the sealant resin layer 312 of the first sheet 31. By enhancing the strength of the second sheet 32, damage to the second sheet 32 on the occasion of deep drawing mentioned later may be prevented suitably.

The first laminate sheet portion 21 is obtained through deep drawing in the state of being joined to the first conductive plate 18. Namely, drawing processing is performed on the first laminate sheet portion 21. Thereby, the first laminate sheet portion 21 has a shape that opens upward and downward. A flange portion 21f bent outward is provided at a lower opening end of the first laminate sheet portion 21.

The second laminate sheet portion 22 is obtained through deep drawing in the state of being joined to the second conductive plate 19. Namely, drawing processing is also performed on the second laminate sheet portion 22 as with the first laminate sheet portion 21. Thereby, the second laminate sheet portion 22 has a shape that opens upward and downward. A flange portion 22f bent outward is provided at an upper opening end of the second laminate sheet portion 22.

The first laminate sheet portion 21 and the second laminate sheet portion 22 have housing recesses 21c, 22c for housing the power storage module 1 inside. The housing recesses 21c, 22c cover a part of the first principal surface 91, a part of the second principal surface 92, and the peripheral surface 93 in the power storage module 1.

In detail, the housing recesses 21c, 22c cover the peripheral edge portion of the upper surface and the peripheral edge portion of the lower surface of the power storage module 1, and the peripheral surface of the power storage module 1. In detail, the housing recesses 21c, 22c cover the peripheral edge portion of the upper surface and the peripheral edge portion of the lower surface of the laminated electrode body 10, and the peripheral surface of the laminated electrode body 10. The center portion of the upper surface of the laminated electrode body 10 is covered by the first conductive plate 18. The center portion of the lower surface of the laminated electrode body 10 is covered by the second conductive plate 19.

For example, the housing recesses 21c, 22c are constituted of sites formed through the aforementioned drawing processing on the first laminate sheet portion 21 and the second laminate sheet portion 22. Note that, not limited to these sites, the housing recesses 21c, 22c may be provided so as to be able to house the laminated electrode body 10. Moreover, while there has been exemplarily described above the case where housing recesses are provided in both the first laminate sheet portion 21 and the second laminate sheet portion 22, a housing recess may be provided in only one of the first laminate sheet portion 21 and the second laminate sheet portion 22.

The first sheet 31 has an inner end portion 31i positioned on the center side of the laminated electrode body 10. The second sheet 32 has an inner end portion 32i positioned on the center side of the laminated electrode body 10. Each resin sheet 50 has an inner edge portion 50i positioned on the center side of the laminated electrode body 10, and an outer edge portion 50c.

In order to secure insulating distances between both the first metal layer 310 included in the first sheet 31 and the second metal layer 320 included in the second sheet 32 and both the first conductive plate 18 and the second conductive plate 19, the inner edge portions 50i are positioned more on the center side of the laminated electrode body 10 than the inner end portions 31i, 32i.

The first conductive plate 18 has an outer edge portion 18c. The second conductive plate 19 has an outer edge portion 19c. The inner end portions 31i, 32i are positioned more on the center side of the laminated electrode body 10 than the outer edge portions 18c, 19c.

Portions where the first conductive plate 18 and the second conductive plate 19 overlap with the resin sheets 50 are welded. The joining interfaces at the overlapping portions are sealed.

While the outer edge portions 50c of the resin sheets 50 are positioned outward of the outer edge portions 18c, 19c, not limited to this, the outer edge portions 50c may be flush with the outer edge portions 18c, 19c.

By joining the first sheet 31 and the second sheet 32 to the first conductive plate 18 and the second conductive plate 19 via the resin sheets 50, the first conductive plate 18 and the second conductive plate 19 can be restrained from making short circuit via the first sheet 31 having the first metal layer 310 or the second sheet 32 having the second metal layer 320.

Next, the structure body 60 is described. As mentioned above, the structure body 60 is housed in the exterior body 20. As shown in FIG. 3, the structure body 60 is arranged in the state of facing the peripheral surface 93 (end surface 93a, 93c, in detail) of the power storage module 1.

FIG. 4 is a perspective view of the structure body 60. In this example, as shown in FIG. 4, the structure body 60 has a box shape. The structure body 60 is typically formed of resin. The structure body 60 includes a base portion 61 extending in the DR3 direction in lateral view of the power storage module 1 (refer to FIG. 3).

The structure body 60 further includes two wall portions 62, 64 that extend from the base portion 61 in the DR2 direction that is oriented toward the peripheral surface 93, the two wall portions 62, 64 being parallel to the first principal surface 91 of the power storage module 1. The structure body 60 further includes two wall portions 63, 65 that extend from the base portion 61 in the DR2 direction that is oriented toward the peripheral surface 93, the two wall portions 63, 65 being perpendicular to the first principal surface 91.

The wall portions 62, 63, 64, 65 standing from the base portion 61 are consecutive in this order. The wall portion 62 is positioned on the first conductive plate 18 side. The wall portion 64 is positioned on the second conductive plate 19 side. The base portion 61 and the wall portions 62, 63, 64, 65 form a rectangular solid space 690 having an opening.

The structure body 60 has an outer surface 60s and an inner surface 60t that is more on the peripheral surface 93 side than the outer surface 60s. In the structure body 60, a through-hole 60h that penetrates from the inner surface 60t to the outer surface 60s is formed. In detail, in this example, the through-hole 60h is formed in the wall portion 62. The through-hole 60h is formed at the center portion of the wall portion 62 in the DR3 direction.

The first and second laminate sheet portions 21, 22 constituting the exterior body 20 (refer to FIG. 1) is arranged so as to cover the outer surface 60s of the structure body 60. In detail, the second sheets 32 of the first and second laminate sheet portions 21, 22 (refer to FIG. 3) are arranged so as to cover the outer surface 60s of the structure body 60. As shown in FIG. 3, the second sheet 32 of the first laminate sheet portion 21 covers an opening end of the through-hole 60h on the outer surface 60s side.

Between the inner surface 60t that is as a portion of the base portion 61 in the structure body 60 and the end surface 93a of the power storage module 1, the second sheets 32 of the first and second laminate sheet portions 21, 22 form a sealed internal space 800 as shown in FIG. 3. The internal space 800 is evacuated so as to have a negative pressure relative to a pressure (atmospheric pressure in this example) of an external space of the laminated battery 100. In this example, the internal space 800 is evacuated at about 1 kPa (kilopascal) in the initial state. The internal space 800 is in a low vacuum state by such vacuum drawing. A restraining force is exerted on the laminated electrode body 10 with the pressure difference, originated from such evacuation, between the internal space 800 and the external space of the laminated battery 100.

As above, the laminated battery 100 as an example of the power storage apparatus includes the power storage module 1 having the laminated electrode body 10 and having the first and second principal surfaces 91, 92 and the peripheral surface 93 perpendicular to the first and second principal surfaces 91, 92. As shown in FIGS. 3 and 4, the laminated battery 100 further includes the structure body 60 having the outer surface 60s and the inner surface 60t that is more on the peripheral surface 93 side than the outer surface 60s, the structure body 60 being arranged in the state of facing the peripheral surface 93. As shown in FIG. 2 and FIG. 3, the laminated battery 100 further includes the exterior body 20 housing the power storage module 1 and the structure body 60.

As shown in FIG. 3, the exterior body 20 further includes the first and second laminate sheet portions 21, 22 arranged so as to cover the outer surface 60s. As shown in FIG. 3, between the inner surface 60t and the peripheral surface 93, the internal space 800 sealed with the first and second laminate sheet portions 21, 22 is formed. The internal space 800 is evacuated so as to have a negative pressure relative to a pressure of the external space of the laminated battery 100. As shown in FIG. 3 and FIG. 4, in the structure body 60, the through-hole 60h penetrating from the inner surface 60t to the outer surface 60s is formed.

Now, there is also a concern that air (nitrogen, oxygen, or the like) intrudes into the internal space 800 of the laminated battery 100 from the outside of the laminated battery 100. For example, when there is some trouble on welding of the first laminate sheet portion 21 and the second laminate sheet portion 22, air can intrude through a gap between the flange portion 21f and the flange portion 22f. Accordingly, after manufacturing of the laminated battery 100 and before shipping of the laminated battery 100 or loading thereof in a vehicle, it is needed to inspect the pressure (inner pressure) of the internal space 800.

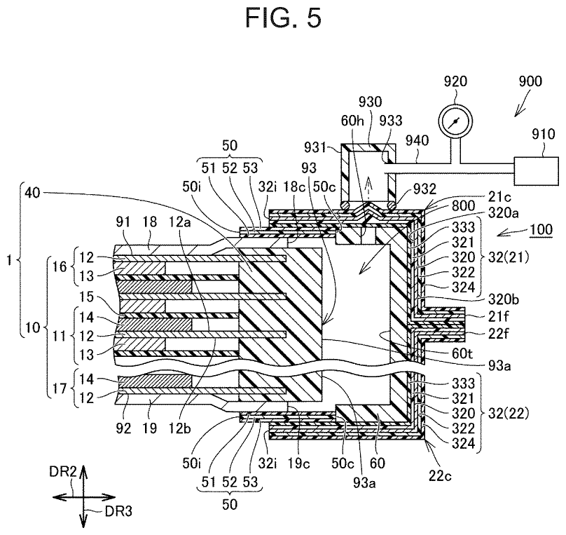

FIG. 5 is a view for explaining a measurement technique of the inner pressure of the internal space 800 in the laminated battery 100. As shown in FIG. 5, the inner pressure of the internal space 800 is measured by an inspection apparatus 900. The inspection apparatus 900 includes a suction apparatus 910, a pressure gauge 920, a chamber 930, and a piping 940. The suction apparatus 910, the pressure gauge 920, and the chamber 930 communicate with one another through the piping 940. Note that, in this example, the chamber does not mean a space itself but means a member for forming the space.

The suction apparatus 910 includes not-shown pump, control apparatus, and the like. The chamber 930 includes a main body 931 and an O-ring 932. In this example, the main body 931 has a shape of a container turned upside down. In this example, the main body 931 is transparent. The main body 931 is formed of resin and the like. An opening end (lower end) of the main body 931 has a ring shape. To the opening end, the O-ring 932 is attached with an adhesive agent or the like. A through-hole 923 for inserting the piping 940 into the chamber 930 is formed on a lateral surface of the main body 931.

In inspection with the inspection apparatus 900, an inspector moves at least one of the inspection apparatus 900 and the laminated battery 100 such that the chamber 930 is positioned above the through-hole 60h of the structure body 60 and the O-ring 932 is pressed onto the second sheet 32. In detail, the inspector relatively moves the inspection apparatus 900 and the laminated battery 100 such that the through-hole 60h is positioned inside the O-ring 932 in top view of the laminated battery 100 and the O-ring 932 is pressed onto the fourth resin layer 324 of the second sheet 32. Namely, the inspection apparatus 900 and the laminated battery 100 are relatively moved such that an opening end of the outer surface 60s of the through-hole 60h is enclosed by the O-ring 932 in top view of the laminated battery 100 and the O-ring 932 is in contact with the fourth resin layer 324. Note that at least one of the inspection apparatus 900 and the laminated battery 100 may be moved.

In this state, the inspector operates the suction apparatus 910 to suction air inside the chamber 930. The suction starts to reduce the pressure inside the chamber 930. The inspector can examine the pressure inside the chamber 930 with the pressure gauge 920.

The suction further proceeding, when the pressure in the chamber 930 goes below the pressure in the internal space 800 of the laminated battery 100, the second sheet 32 of the first laminate sheet portion 21 is pulled to the chamber 930 side. As a result, as shown in FIG. 5, the second sheet 32 takes a state of being partly drawn into the chamber 930. Namely, a location that covers the through-hole 60h out of the second sheet 32 takes a state of being convex upward. By examining the value (memory in this example) of the pressure gauge 920 at the time when such a state change occurs, the inspector can come to know the pressure of the internal space 800 of the laminated battery 100. Namely, according to the laminated battery 100, the inner pressure of the internal space 800 after reduced-pressure sealing of the laminated battery 100 can be readily measured.

Since the pressure of the internal space 800 of the laminated battery 100 can be measured with the inspection apparatus 900 as above, the pressure of the internal space 800 can be measured even when vacuum drawing with the whole power storage apparatus put into a chamber is not performed. If vacuum drawing with the power storage apparatus put into a chamber is performed, there arises a concern that restraining of the laminated electrode body 10 is released due to deformation or the like of conductive bodies at the outermost layers (conductive bodies corresponding to the first conductive plate 18 and the second conductive plate 19).

Nevertheless, according to the laminated battery 100 of this example, it is not needed to put the whole laminated battery 100 into a chamber. Therefore, restraining of the laminated electrode body 10 is not released due to measurement of the pressure of the internal space 800. Therefore, the laminated battery 100 high in quality can be provided.

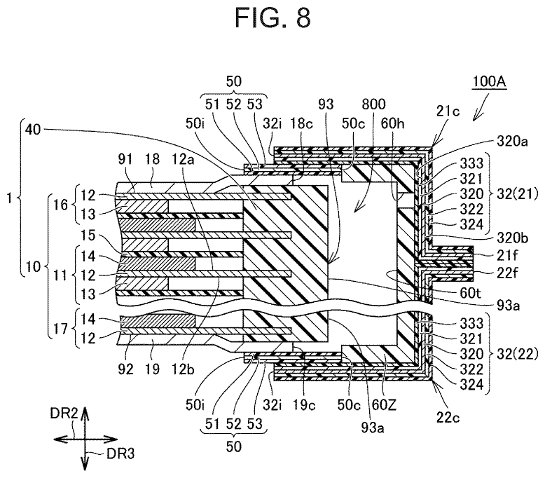

In this example, as shown in FIG. 4, the through-hole 60h extends in the DR3 direction. Accordingly, the inspector presses the chamber 930 onto the second sheet 32 of the first laminate sheet portion 21 from the above. Therefore, the inspection is easy. Furthermore, this more enhances flexibility of arranging the piping 940 caused by spacing thereof as compared with a configuration (refer to FIG. 8) in which the through-hole 60h is formed in the base portion 61.

As shown in FIG. 4, the through-hole 60h is formed in the wall portion 62. Therefore, the through-hole 60h can extend in the DR3 direction (laminating direction) and the internal space 800 can be secured with the structure body 60. Moreover, the opening end of the through-hole 60h on the outer surface 60s side can be covered with the second sheet 32.

The structure body 60 has a box shape. Accordingly, the internal space 800 can be sufficiently secured by the structure body 60. Furthermore, the second sheet 32 can be reinforced from the inner side of the laminated battery 100 by the structure body 60.

FIG. 6A, FIG. 6B, FIG. 6C, FIG. 6D, FIG. 6E, FIG. 6F, and FIG. 6G are views for explaining a method of manufacturing the first laminate sheet portion 21. As shown in FIG. 6A, a plate of aluminum, resulting in the first conductive plate 18, is prepared. As shown in FIG. 6B, two resin sheets 50 are welded along two long sides of the plate of aluminum. Next, as shown in FIG. 6C, two resin sheets 50 are welded along two short sides of the plate of aluminum. The resin sheets 50 on the long sides and the resin sheet 50 on the short sides overlap at four corners shown in FIG. 6C.

As shown in FIG. 6D, to each of the two resin sheets 50 on the long sides, two resin sheets 70 are welded. In this example, each resin sheet 70 has an equivalent layer structure to that of the resin sheet 50. The two resin sheets 70 on the right side in the figure are spaced from each other in the DR2 direction and extend in the DR1 direction. Likewise, the two resin sheets 70 on the left side in the figure are also spaced from each other in the DR2 direction and extend in the DR1 direction. The four resin sheets 70 are welded to the resin sheets 50 on the long sides in the state of protruding from the resin sheets 50 in the directions opposite to the plate of aluminum.

As shown in FIG. 6E, one first sheet 31 is welded to the resin sheet 50 and the two resin sheets 70 on the right side in the figure. Likewise, one first sheet 31 is also welded to the resin sheet 50 and the two resin sheets 70 on the left side in the figure. Each first sheet extends in the DR2 direction. The first sheets are longer than a separating distance between the resin sheets 70 in the DR2 direction.

As shown in FIG. 6F, one second sheet 32 is welded to the resin sheet 50 on the upper side in the figure, the two resin sheets 70 on the upper side in the figure, and end portions of the two first sheets 31 (end portions on the upper side in the figure). The second sheet 32 has a U-shape. Likewise, one second sheet 32 is welded to the resin sheet 50 on the lower side in the figure, the two resin sheets 70 on the lower side in the figure, and end portions of the two first sheets 31 (end portions on the lower side in the figure). The second sheets 32 take a state of being spaced from and facing each other in the DR2 direction. Note that the intermediate for the first laminate sheet portion 21 shown in FIG. 6F is in axial symmetry with respect with both the DR1 direction and the DR2 direction.

Through drawing processing on the intermediate along a virtual line L, the first laminate sheet portion 21 is formed as shown in FIG. 6G. The flange portion 21f of the first laminate sheet portion 21 is formed by the drawing processing.

Note that the first laminate sheet portion 21 and the second laminate sheet portion 22 have equivalent shapes. The second laminate sheet portion 22 is also manufactured by the similar method to that for the first laminate sheet portion 21. Therefore, description of the method of manufacturing the second laminate sheet portion 22 is not herein repeated.

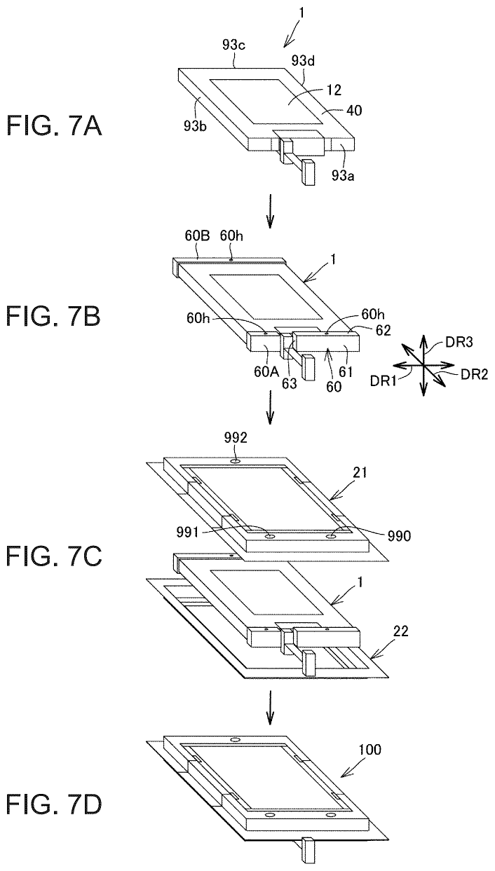

FIG. 7A and FIG. 7B are views for explaining a method of manufacturing the laminated battery 100 of the power storage module 1, the structure body 60, and the exterior body 20. As shown in FIG. 7A and FIG. 7B, the structure body 60 is installed on one of the two short sides of the power storage module 1. The structure body 60 is installed at a position facing the end surface 93a constituting the peripheral surface 93 of the power storage module 1.

In this example, the laminated battery 100 further includes structure bodies 60A, 60B. The structure bodies 60A, 60B have the similar structures and function to those of the structure body 60. Through-holes 60h are formed in the structure bodies 60A, 60B. The structure body 60A has a smaller length in the DR1 direction than the structure body 60. The structure body 60B has a larger length in the DR1 direction than the structure body 60. As with the structure body 60, the structure bodies 60A, 60B are housed in the exterior body 20.

The structure body 60A is installed on the same side as that of the structure body 60. As with the structure body 60, the structure body 60A is installed such that the opening side faces the end surface 93a. The structure body 60B is installed on the opposite short side to the structure body 60. The structure body 60B is installed at a position facing the end surface 93c of the power storage module 1. In detail, the structure body 60B is installed such that the opening side faces the end surface 93c. In the DR1 direction, the through-hole 60h of the structure body 60, the through-hole 60h of the structure body 60A, and the through-hole 60h of the structure body 60B are at different positions.

As shown in FIG. 7C, the power storage module 1 and the three structure bodies 60, 60A, 60B are sandwiched by the first laminate sheet portion 21 and the second laminate sheet portion 22. Note that the second laminate sheet portion 22 is in the state of being turned over. After that, by welding the first laminate sheet portion 21 and the second laminate sheet portion 22 together, the laminated battery 100 is completed as shown in FIG. 7D.

Note that, in order to make the positions of the through-holes 60h readily visually recognized, marks 990, 991, 992 may be printed on the first laminate sheet portion 21. The mark 990 indicates the position of the through-hole 60h of the structure body 60. The mark 991 indicates the position of the through-hole 60h of the structure body 60A. The mark 992 indicates the position of the through-hole 60h of the structure body 60B.

Note that the through-holes 60h are not necessarily formed in the structure bodies 60A, 60B. Any one of the structure bodies 60, 60A, 60B may have one through-hole 60h formed. In the case of a configuration of automatically inspecting the pressure of the internal space 800 by the inspection apparatus 900, the marks 990, 991, 992 are not needed.

### Modifications

(1) FIG. 8 is a view showing a modification of the laminated battery 100. As shown in FIG. 8, a laminated battery 100A is different from the laminated battery 100 in including a structure body 60Z in place of the structure body 60.

The structure body 60Z has a through-hole 60h formed in the base portion 61 (refer to FIG. 4), not in the wall portion 62. In the case of such a configuration, the chamber 930 (FIG. 5) of the inspection apparatus 900 may be pressed onto a lateral portion of the second sheet 32 so as to be relatively moved in the DR2 direction.
(2) The shape of the structure body 60 is not limited to a box shape. The structure body 60 may have a shape like an H-shaped steel extending in the DR2 direction. The structure body 60 may have a shape at least having the base portion 61 and the wall portion 62. The shape of the base portion 61 is not limited to a rectangular solid shape. For weight saving, notches (through-holes or the like) may be formed in the base portion 61 and the wall portions 62 to 65.

The embodiment having been disclosed above is illustrative and not restrictive in all respects. The scope of the present disclosure is indicated by the claims and all the alterations thereof are included within the spirit and scope of the claims and their equivalents.

What is claimed is:

1. A power storage apparatus comprising:
a power storage module having an electrode body and having a principal surface and a peripheral surface perpendicular to the principal surface;
a structure body that has an outer surface and an inner surface more on the peripheral surface side than the outer surface and is arranged in a state of facing the peripheral surface; and
an exterior body housing the power storage module and the structure body, wherein:
the exterior body includes a laminate sheet body arranged so as to cover the outer surface;
between the inner surface and the peripheral surface, a sealed internal space is formed with the laminate sheet body;
the internal space is evacuated so as to have a negative pressure relative to a pressure of an external space of the power storage apparatus; and
a through-hole penetrating from the inner surface to the outer surface is formed in the structure body.

2. The power storage apparatus according to claim 1, wherein:
the electrode body is a laminated electrode body having a plurality of electrodes laminated in a first direction perpendicular to the principal surface; and
the through-hole extends in the first direction.

3. The power storage apparatus according to claim 2, wherein:
the structure body has
a base portion extending in the first direction in lateral view of the power storage module, and
a wall portion extending from the base portion in a second direction that is oriented toward the peripheral surface, the wall portion being parallel to the principal surface; and
the through-hole is formed in the wall portion.

4. The power storage apparatus according to claim 3, wherein the structure body has a box shape.
